(19) United States
(12) Patent Application Publication
(10) Pub. No.: US 2007/0050361 A1
(43) Pub. Date: Mar. 1, 2007

(54) Method for the discovery, ranking, and classification of computer files

(76) Inventor: Eyhab Al-Masri, Waterloo (CA)

Correspondence Address: Eyhab Al-Masri, 570 Buckingham Blvd, Waterloo, ON, N2T 2T8, CA

(21) Appl. No.: 11/501,811

(22) Filed: Aug. 10, 2006

Related U.S. Application Data
(60) Provisional application No. 60/712,120, filed on Aug. 30, 2005.

(51) Int. Cl. G06F 7/00

(52) U.S. Cl. 707/7

(57) ABSTRACT

A method for ranking files on a computer system that at least includes: establishing a catalog of at least a portion of computer files, establishing a plurality of ranking policies, choosing a plurality of threshold values for taxonomic classification; for each file encountered, determine the total weight with respect to ranking policies; ranking each file according to weight accumulation; and possibly classifying each file based on a level associated with the combination of the weight values.

### CROSS REFERENCE TO RELATED APPLICATION

This application claims the benefit of U.S. Provisional Patent Application Ser. No. 60/712,120, entitled “Dynamic Approach for Computer Files Ranking and Categorization,” filed by Eyhab Al-Masri on Aug. 30, 2005.

### FIELD OF THE INVENTION

A method assigns ranks to files on a computer system. The rank assigned to a file is calculated from the knowledge acquisition gained through the interaction that users have with computer systems. The present invention is particularly useful for efficiently discovering information on a computer system and relates to a precursor of operations such as desktop search, backup, migration, synchronization, and semantic interpretation.

### BACKGROUND OF THE INVENTION

The advancement in networking technology has introduced new paradigms in computer communication and has profoundly contributed to how people are creating, exchanging and perceiving information. This is becoming more evident as computers constitute a major part of our daily life activities and by far are changing users' information access patterns. In recent years, advances in miniaturization; low-power circuit design, development in telecommunications, and increase in user demand for creating, and exchanging information have driven the deployment of a wide array of ubiquitous systems to perform such tasks. The plethora of applications that can be installed on operating systems enabled people to use computer systems to create and store user-related information in the form of files. The increase in the number of files stored on a computer system, either created by users or applications, hinders the ability to quickly and instantly discover information contained within files due to many reasons, most notably, the variation of file formats that are mainly preserved by software vendors. Therefore, finding files on computer systems quickly and accurately is becoming very challenging. For example, a user who filed an electronic tax return form that is three or four years old, does not have to endlessly search a computer system with thousands of files for only finding this type of information. While computer systems enabled users to create, modify, and exchange information in the form of files, it is becoming apparent that discovering information efficiently is the next challenging task.

Due to the emergence of the internet and the continuing improvements in the means of transferring data between computer systems, the ability to discover and organize this growing data becomes a challenge particularly when attempting to find specific information contained within files. Nevertheless, the overlapping of folder structures adds an additional level of sophistication to the task of differentiating between user, application, and system files. In addition, the preservation, synchronization, backup, and migration of computer files become more problematical as new technological improvements significantly contribute to the increase in the number of computer files. Apart from the problems regarding file organization techniques to data of increasing magnitude, there are new technical challenges involved with using traditional file discovery methods (such as filename, keyword, extension, etc. . . . ) to find relevant information for many processing tasks such as desktop search, backup, synchronization, migration, and semantic interpretation.

There are several commercially available software tools that enable computer users with various operations such as desktop search, backup, synchronization, and migration. Nevertheless, there exist several approaches that aid the ability to find, backup, restore, synchronize, and migrate computer files. Some approaches attempt to discover files necessary for a certain operation through examining a limited set of predefined file types on a computer system. Other approaches attempt to discover files through examining files that are associated with certain dates. However, these approaches, as a result of limited search related features, return tens or hundreds of irrelevant files which in turn makes the task of finding relevant information within these results more time consuming and less productive.

What is needed is a method that intelligently takes advantage of user interactions with a computer system for ranking and classifying computer files. Improvements to such approaches have been developed which attempt to use a very limited number of file related features to analyze a computer system and locating files for operations such as desktop search, backup, synchronization, migration, and semantic interpretation. The precision in determining how to analyze these files is often ignored and the quality of results produced by current approaches are low or inefficient. Furthermore, current approaches do not provide the necessary tools for users to control the discovery process of their computer systems. In addition, current approaches exclude the use cognitive feedback and knowledge acquisition gained from the interaction users have with their computer systems, and do not provide the capability to distinguish between user- and system-related files. The present invention is an improvement over traditional approaches and has the ability of ranking and classifying files located on a computer system in such a way that can tailored to the user's particulars or used for further processing.

A computer system typically contains a repository of files with different types authored by operating systems, applications and users. As the computer system storage size has grown, it has acquired an immense value as an active and evolving repository of information. The richness of applications with proprietary file formats has made it progressively more difficult for standardizing ways to leverage the value of information contained within files. Although the continuous growth of storage size on a computer system leads to nonstandard form and content where data is semistructured or unstructured, there is hope for finding ways to enhance the mechanisms of discovering files within the scope of what people are familiar with.

What is therefore desirable but not taught nor suggested by the prior art, is a method that takes advantage of the cognitive feedback and knowledge acquisition gained through the interaction users have with their computer systems, extracting features about files, considering relationships between files, classifying the importance of files, and automating the discovery process of information contained within files which function as the basis for ranking policies, and provide users with the flexibility to customize and personalize the ranking scheme.

### SUMMARY OF THE INVENTION

In spite of limitations and deficiencies of the current existing tools for the discovery of files on a computer system, the present invention provides a method to automate the discovery of files and produces high quality results based on the notion of file ranking and classification. In particular, there are adequate features that can be extracted about files which provide valuable information that significantly contribute to producing high quality ranking results. One characteristic of the present invention provides an objective ranking of files based on features, often referred to as attributes, which can be extracted about files. Another characteristic provides an objective ranking based on relevant information that can be extracted via the operating system's central repository.

The present invention also provides a framework for controlling and managing the ranking of files based on the extraction of file and operating system features. Another characteristic of the present invention aims at ranking files within a computer system based on information contained within these files. Another characteristic of the present invention is to provide a scalable and extensible file ranking method which can apply to large number of files or large portions of computer systems. Another characteristic of the present invention is to provide a framework for the automatic discovery, ranking, and classification of files based on the establishment of ranking policies. Another characteristic of the present invention aims at providing a classification method. Other characteristics of the present invention will become apparent in the view of the following description and associated figures.

The present invention provides a method for adapting to automatically rank computer files at least including: a computer system examiner adapted to scan at least a portion of computer files; a repository builder adapted to establish plurality of collecting information; a policy organizer adapted to manage and adjust plurality of ranking policies; an analyzer adapted to evaluate and process files according to an established ranking policies; a ranker adapted to compute the ranking of files in accordance with the accumulation of weights and a ranking scheme; a classifier adapted to use taxonomies for categorizing files in accordance with plurality of ranking policies; and an integrator adapted to incorporate other supplementary operations serving as a connector with additional processes.

### BRIEF DESCRIPTION OF THE DRAWING FIGURES

Features and advantages of the present invention will become apparent to those skilled in the art from the description below, with reference to the following drawing figures, in which:

FIG. 1 is a schematic diagram of the present invention for ranking of computer files;

FIG. 2 is schematic diagram of the File Discovery, Ranking, and Classification (FDRC) portion of the method of FIG. 1;

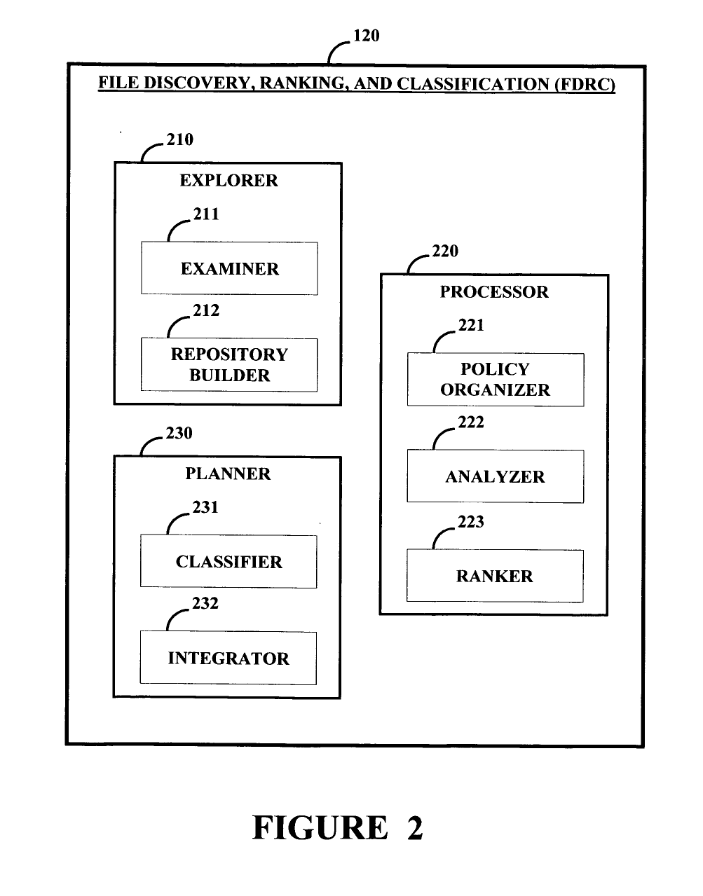

FIG. 3 is a flowchart detailing the Explorer portion of the present invention method;

FIG. 4 is a flowchart detailing the Processor portion of the present invention method;

FIG. 5 is a flowchart detailing the Planner portion of the present invention method; and

FIG. 6 is a schematic diagram of the Policy Organizer Feature Extraction portion of the method.

### DESCRIPTION OF THE DESIGN, IMPLEMENTATION, AND THE PREFERRED EMBODIMENTS

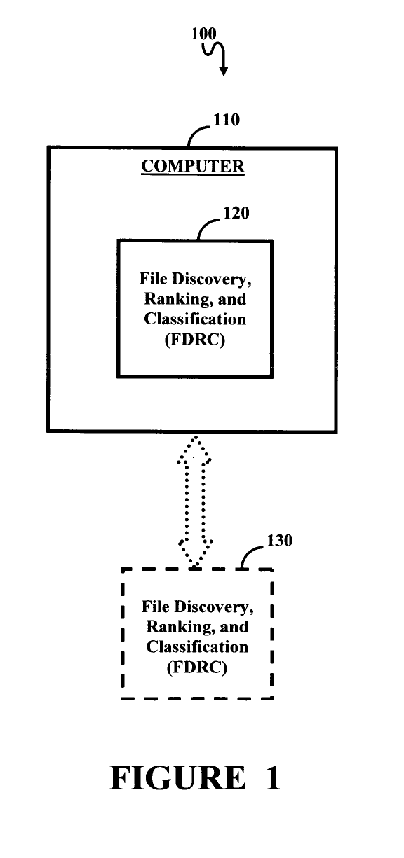

A schematic diagram of the present invention 120 for the ranking of computer files is shown on FIG. 1. The computer 110 shown does not have to be limited to commonly used systems such as desktop or notebook variety, but other electronic devices and systems may also be used in the present-inventive discovery, ranking, and classification method. The present invention, referred to here as the File Discovery, Ranking, and Classification (FDRC) 120, is a method that can be integrated into a software tool and can be installed on a computer system 110. The FDRC 120 can also be deployed or executed alternatively through the internet or can externally reside to the computer 110 as shown by the option labeled 130.

Information on a computer system can reside on one or more storage devices governed by one or more operating systems. The operating system serves as an integral part of a computer and acts as intermediary between the users and hardware. The operating system is responsible for allocating resources to perform tasks as well as translating user actions to execute requests. The ability for users to communicate and interact with computer systems is facilitated through the use of operating systems, and therefore an operating system has to have the ability to effectively manage the storage of information. However, the growth of computer system storage sizes and the propagation of the internet have been contributing factors for the information overload which acts as a deterrent for the quick and easy discovery of information on a computer system. As information on a computer system proliferates, the inability to quickly discover information will become tangible, and the ability to efficiently locate information using current operating system capabilities raises several issues such as precision, performance, and reliability. In addition, the preservation, synchronization, backup, and migration of information, which is of a great importance, become more problematical as new technological improvements continue to increase the number of information in the form of files.

Apart from the problems managing and organizing files to the data of increasing magnitude, there are technical challenges involved in the discovery of files due to the existence of wide variety of file formats and types. However, all files share standard features or attributes that are managed by an operating system which, along with the knowledge acquisition of the interaction between users and computer systems, can provide valuable information to the discovery of files. The FDRC 120 discovers information and content on a computer system 110 symbolically through the explorer module 210. The FDRC 120 examines the contents of a computer system 110 to consider files through an examiner component 211, and builds a repository of collected data through a repository builder component 212. The FDRC 120 handles the information discovered using the processor module 220. Once the repository builder 212 finalizes files considered for ranking, the FDRC 120 retrieves the ranking policies from the policy organizer component 221. The policy organizer 221 acts as a manager for the policies that function as a ranking plan for the FDRC 120 and determines the weight value for each policy. The weights and the values contributed by policies can be adjusted via the policy organizer 221. The FDRC 120 (symbolically via the analyzer component 222) begins an evaluation process for encountered files using matching criteria linking features extracted from the explorer component 211 to policies defined in the policy organizer 221. The FDRC 120 (symbolically via the analyzer component 222) also determines for each encountered file the score based on the total accumulation of weights defined by the policy organizer 221 and as a result of the matching criteria. The FDRC 120 further ranks encountered files (symbolically via ranker component 223).

In the preferred embodiment, all encountered files are ranked and are presented to the user with a ranking through the planner module 230, allowing the user to determine files that are more important than others, and therefore are appropriate for further processing (i.e. desktop search, backup, migration, synchronization, semantic interpretation etc. . . . ) symbolically using the integrator component 232. In an alternate embodiment, the FDRC 120 can automatically categorize encountered files through the classifier component 231) using taxonomies to identify files that are important and appropriate for further processing (i.e. desktop search, backup, migration, synchronization, semantic interpretation, etc. . . . ) into one or more collections, and identify all other files in a separate collection not recommended for further processing or should nonetheless be ignored. Those skilled in the art to which the present invention pertains will appreciate that the FDRC 120 can use scripts, connectors, or integrate the use of mark language techniques to accomplish the collection operation or classification using taxonomies and automatically select the appropriate files for further processing (i.e. desktop search, backup, migration, synchronization, semantic interpretation, etc. . . . ).

The level of granularity and precision of the ranking is dependent on the amount of details that can be collected about files. Apart from the complexity of non-uniformity in file formats, files share common features (i.e. filename, extension, date created, date modified, etc. . . . ). Examining files based on the features extracted provides to some extent valuable knowledge about the content of files. Nevertheless, adding another level of granularity on how to apply these file features into policies provides a higher level of detail about files as well as users, and therefore more features that can be extracted through file properties provide significant information adapted for ranking and producing high quality results. In addition, a system repository or database (i.e. registry) can also provide additional information (i.e. Most Recently Used—MRU, Recent Documents, etc. . . . ). The FDRC 120 in the present invention takes advantage of feature extraction from both files as well as operating systems to rank files and produce high quality results. The definition of FDRC 120 is more complex and subtle than simple summation of weights contributed by features that are associated with policies. Additionally, there can be a degree of sophistication to expand the feature extraction of policies into levels of priority in which some features may contribute higher weights than others. There can also be other degrees of sophistication to expand the ranking policies and the result schema by means of providing ontologies that resemble faceted taxonomies, and semantic relationships among terms and features. As the number of features extracted about files increase, the FDRC 120 yields more accurate results, and therefore a file that is determined to have a high score (i.e. based on the total number of weights accumulated) yields higher file rank.

In order to illustrate the present method of file ranking, consider a simple practical example of four files: StarWars.mpg, FavMusic.mp3, TaxReturn01.tax, desktop.ini; and four policies: location, date accessed, most recently used (MRU), file extension. Assume that the following files are stored on Microsoft Windows based computer system and have been encountered by the FDRC 120, the date of the FDRC 120 being applied is on Jul. 21, 2006 and there exist three taxonomies for classifying files (high, medium, and low).
1) StarWars.mpg: location: % desktop %, extension: mpg, accessed: Jul. 2, 2005, does not appear in MRU
2) FavMusic.mp3: location: % my music %, extension: mp3, accessed: May 2, 2006, does appear in MRU
3) TaxReturn01.tax: location: C:\Taxes, extension: tax, accessed: Apr. 10, 2006, does appear in MRU
4) desktop.ini: location: % desktop %, extension: ini, accessed: Jul. 20, 2006, does not appear in MRU

The results of the FDRC 120 file ranking 223 and file classification 231 are:

| | | |
|---|---|---|
| 2) FavMusic.mp3 | Rank: 93% | Taxonomy: High |
| 3) TaxReturn01.tax | Rank: 86% | Taxonomy: High |
| a) StarWars.mpg | Rank: 75% | Taxonomy: Medium |
| 4) desktop.ini | Rank: 35% | Taxonomy: Low |

The second file, “FavMusic.mp3”, receives the highest ranking (93%) and classified as “High” for being located in the % my music % folder, being one of the recently accessed file (with “recent” being definable), does not appear to be a system file (with “system file” being definable), file extension belongs to a list of popular extensions (with “popular extensions” being definable), and listed in the most recently used (MRU) (with “MRU” being definable). Although file 3) shares some similarities with file 2), the third file, “TaxReturn01.tax”, receives slightly less ranking (86%) since it does not belong to a list of popular extensions (with “popular extensions” being definable), but is classified under the “High” taxonomic representation since the file access time is somewhat recent (with “somewhat recent” being definable), and contains a reserved keyword “tax” as part of the filename (with “reserved keyword” being definable). The first file, “StarWars.mpg”, receives 75% ranking and is classified as “Medium” since it has the least recent access time (with “least recent” being definable), located in the % desktop % folder, the file is does not appear to be in the MRU list (with “MRU” being definable), however, the file extension belongs to a list of popular extensions (with “popular extensions” being definable). The fourth file, “desktop.ini”, receives 35% ranking and is classified as “Low” since it has an “ini” extension indicating it is a system file (with “system file” being definable), and the file belongs to a list of common system files (with “common system files” being definable). Although file 4), “desktop.ini”, appears to be a system file, it receives a ranking percentage of 35% due to the fact that it is located in the % desktop % folder, and is the most recent accessed file (with “most recent” being definable). The decisions taken by the FDRC 120 when processing files 1) through 4) depend on the weights, taxonomic representation, and other automatic techniques derived from the extraction of features with their associated ranking weights. The classification of the files 1) through 4) can be expanded and the weights assigned by each ranking policy can be adjusted using the policy organizer 221. As illustrated by this example, higher levels of granularity in the extraction of features and the organization of policies yields better chances for having accurate and high quality ranking results. The ranking plan is composed of a set of policies that are feature-based and are compared to the collected information from the repository builder 212 for encountered files. The FDRC 120 determines the contribution of these policies to each file encountered using matching criteria. The FDRC 120 further processes this data to determine the total weight accumulated by encountered files for computing the ranking of files. The FDRC 120 further uses a classifier 231 for the taxonomic representation for files encountered based on the ranking and weight distribution range assigned by the policy organizer component 221.

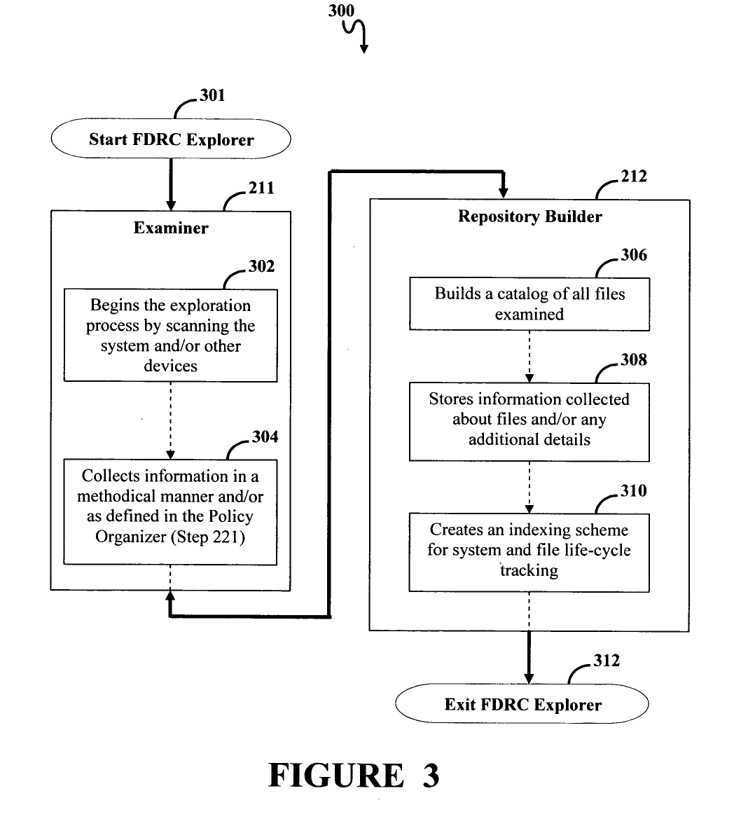

The flowchart in FIG. 3 summarizes the general method 300 used by the FDRC 120 for the exploration of files and operating system 210 used for ranking. The method starts (Step 301) with the examiner module 211 of the exploration process 210 by scanning at least a portion of a computer system 110 (Step 302), and collects information in a methodical order or as defined by the policy organizer 221 (Step 304). The FDRC 120 (symbolically via the repository builder component 212) builds a catalog of files examined (Step 306), stores data collected about files through the extraction of file and operating system information (Step 308), and creates an indexing scheme used to track any changes that occur to the cataloged files to eliminate the possibility of redundant storing of data, and keeping file and operating system information up-to-date (Step 310). The FDRC 120 explorer module exits in Step 312.

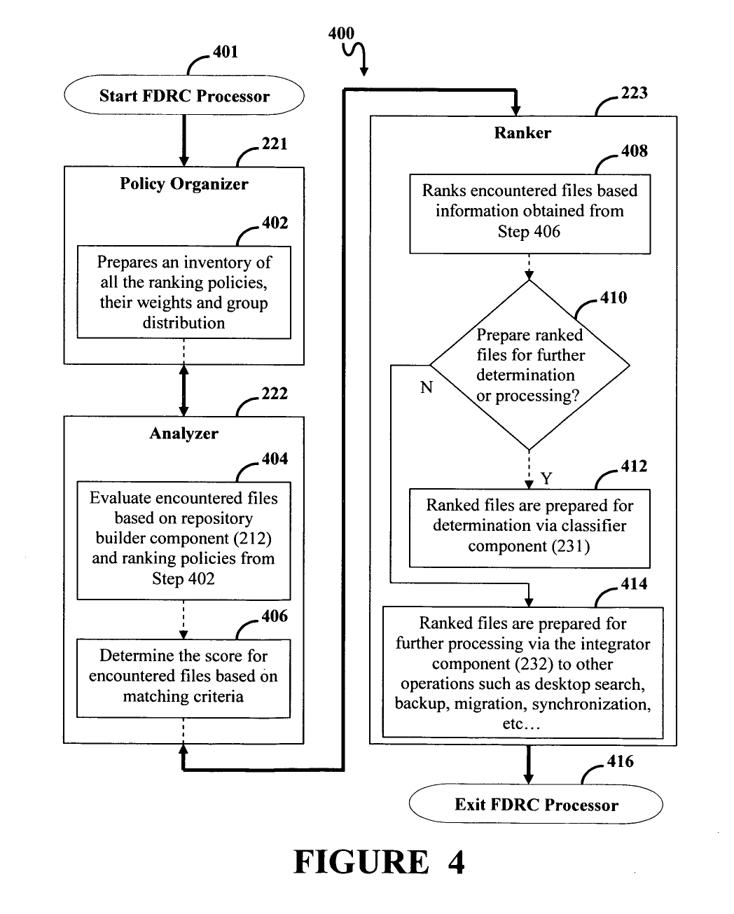

The flowchart in FIG. 4 summarizes the general method 400 used by the FDRC 120 for the processing of files 220 used for ranking. The method follows the FDRC 120 explorer module 210 and starts (Step 401) with retrieving the ranking plan (symbolically via the policy organizer component 221) and preparing an inventory of the ranking policies linked with their weights with any taxonomic representation (Step 402). The FDRC 120 (symbolically via the analyzer component 222) begins evaluating encountered files listed in the repository builder 212 and ranking policies performed (Step 404). The FDRC 120 determines (symbolically via the analyzer component 222) the scores for encountered files based on matching criteria by linking features of the encountered files collected from the repository builder 212 to policies that are satisfied by the ranking plan (via the policy organizer component 221) (Step 406). In Step 408, the FDRC 120 ranks encountered files (symbolically via the ranker 223) and determines (Step 410) whether results will be presented to the user for any further interaction (symbolically via the classifier component 231) (Step 412), or whether the results will be used for further processing to other operations (symbolically via the integrator component 232) (Step 414). The FDRC 210 processor module 220 exits in Step 416.

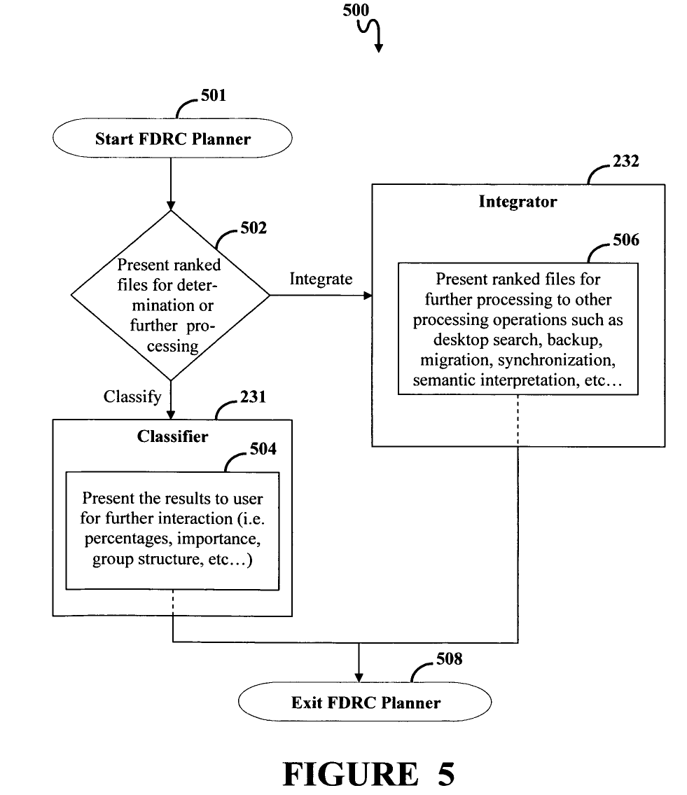

The flowchart in FIG. 5 summarizes the general method 500 used by the FDRC 120 for planning on how to present the ranked results. The FDRC 120 used the explorer module 210 for exploring and building a repository of information about files and operating system, which is followed by the processing module 220 for evaluating and ranking files encountered. As the ranking of files is completed, the next step is to plan how to use the results. The FDRC 120 starts (Step 501) with planning what to do with the results (symbolically via the planner module 230). In Step 502, the FDRC 120 determines whether to classify and present results (i.e. by percentages, taxonomic representation, importance, etc. . . . ) to the user for further interaction (Step 504) using the classifier component 231, or whether the results will be used for additional integration with other components for further processing such as desktop search, backup, synchronization, migration, disaster recovery, semantic interpretation, etc. . . . (Step 506) using the integrator component 232. The method stops in Step 508.

There is a wide variety of features, often referred to as attributes, which can be extracted from files. The ability to effectively rank files and produce high quality ranking results appropriately depend on number of factors. One of the main factors is collecting as many features from files individually as possible. The second factor is collecting information from the operating system (i.e. such as common folder locations, registry database, log files, etc . . . ) about individual files. The collection of both file and operating system information complementing to files can be used as policies for the ranking of files. In addition, the ability to expand the ranking policies into granular ranking strategies provides even more powerful information. The operating system can provide information about the interaction users have with the computer systems including files in many forms such as the Most Recently Used (MRU), Recent Documents, etc. . . .

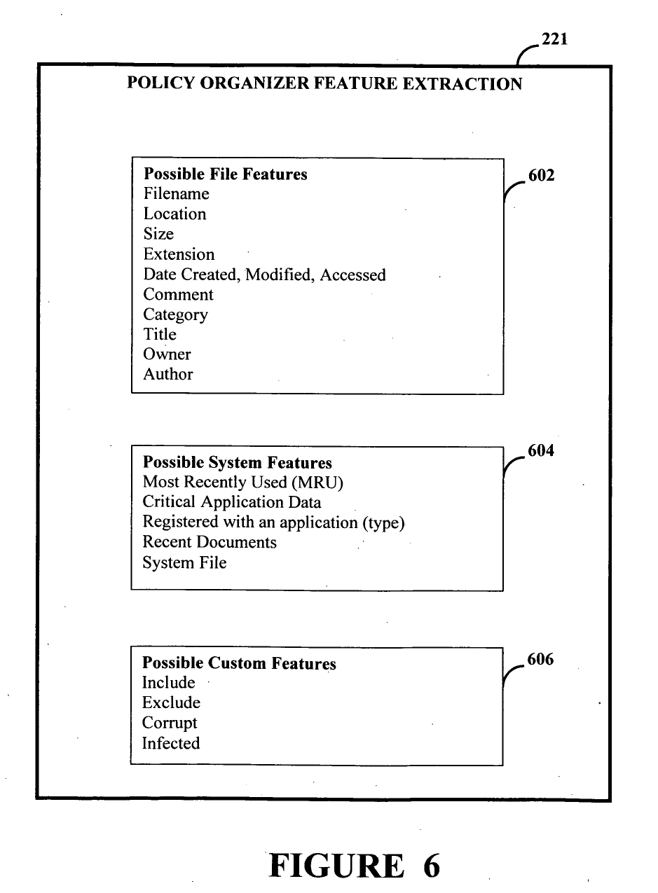

File features that are common across all file types, such as file extensions and date last accessed, for example, can provide significant information that can be acquired about the popularity and usage activity of files within a computer system. On another example, a common location for storing music files in a Microsoft Windows operating system is the “My Music” folder located within the “My Documents” folder. Assume that there exist hundreds of music and video files within this folder; music files that are located in this folder that appear in the MRU list (with “MRU” being definable) under the operating system database will receive higher ranking than those that are not listed. In addition, files that appear in the MRU list and are accessed within the last fives days will eventually higher ranking since they meet one or more ranking policies. The ranking policies can be extended to become even more granular. For example, the date last accessed feature can be extended into one or more policies such that the weight contribution of files accessed within the last five days is more than files accessed within the last ten days. The same concept can be applied throughout the features that are extracted about files and operating systems. The FDRC 120 provides the flexibility of having users control their ranking plan (symbolically via the policy organizer 221) and adding supplementary features to be tailored to the user's particulars. For example, when operating systems provide additional features (i.e. last scanned, last faxed, last emailed, etc. . . . ), the FDRC 120 provides the flexibility of adding these features (symbolically via the policy organizer 221) to include them in the ranking plan. Another example would be custom defined features that are tailored to user's particulars such as an exclude list (with “exclude” being definable) to avoid ranking and presenting these files from the results (i.e. a list of common spyware files, infected files, etc. . . . ). FIG. 6 depicts the policy organizer 221 possible features that can be extracted individually about files 602, operating system 604, and custom defined features 606, however, for anyone of ordinary skill in the art will appreciate that many variations and alterations to file, system, and custom defined features are within the scope of the invention.

The files which are designated for additional operations are presented to the appropriate tool for further processing using the integrator component 232 according to the operation involved such as desktop search, backup, migration, synchronization, and semantic interpretation, however, for anyone of ordinary skill in the art will appreciate that many variations and alterations to presentation and integration of results to other operations within the scope of the invention.

Variations and modifications to the present invention are possible, given the above description. However, all variations and modifications which are obvious to those skilled in the art to which the present invention pertains are considered to be within the scope of the protection granted by this Letter Patent.

What is claimed is:

1. A computer implemented method of ranking a plurality of computer files, the method comprising:
a) establishing a plurality of ranking policies;
b) choosing a weighting factor for each said ranking policy;
c) scanning at least a portion of a computer system;
d) calculating the total weight for each encountered file according to matching criteria;
e) ranking each encountered file; and
f) processing each encountered file according to likely relevance to predetermined taxonomies.

2. The method of claim 1, wherein the said policies include:
considering file-specific information;
considering system-specific information; and
considering custom user-defined information.

3. The method of claim 1, wherein the said policies include:
considering whether a file header contains additional information about title, subject, author, category, keywords, comments, source, rank, importance, revision number, or any additional information;
considering whether a file header contains additional information about indexing searching, and archiving patterns;
considering whether a file header contains additional information about compression and encryption patterns; and
considering whether a file is registered in at least one or more locations in the system repository.

4. The method of claim 1, wherein the said policies include:
considering file associations with the operating system;
considering file usage activities; and
considering search patterns.

5. The method of claim 1, wherein the said policies comprise:
considering at least one or more ranking policies;
considering the taxonomic representation of features;
considering semantic relationships among features; and
considering the grouping of similar or interrelated ranking policies.

6. The method of claim 1, wherein the said policies are modifiable by a user or application via a graphical user interface, browser, script, or markup language.

7. The method of claim 1, wherein the said ranking policy include:
considering at least one or multiple conditions; and
considering at least one or more weighting factors.

8. The method in claim 1, wherein said policies comprising of allowing a user or application to adjust or modify (1) weight factors of each policy, (2) weights across one or more policies, and (3) the grouping of similar and interrelated policies.

9. The method of claim 1, wherein the said weighting factor is modifiable by a user or application via a graphical user interface, script, or markup language.

10. The method in claim 1, further comprising:
collecting information about files;
collecting information about computer system; and
collecting information about at least one of more users.

11. The method in claim 9, further comprising:
building a repository for the collected information; and
creating an indexing scheme for system and file life-cycle tracking.

12. The method in claim 1, further comprising:
analyzing relationships between files;
considering interactions users have with the computer system; and
acquiring knowledge on the user information usage and access patterns.

13. The method in claim 11, further comprising:
evaluating file information according to policy matching criteria; and
determining the total weight accumulated.

14. The method in claim 1, wherein the said matching criteria includes:
determining the number of collected file information matching at least one or more policies; and
determining the total score accumulated according to the number of matching policies.

15. The method in claim 1, further comprising of a file ranker adapted to rank each file according to (1) the number of policies matched, (2) the total weight accumulated, and (3) likely relevance to one or more predetermined taxonomies.

16. The method in claim 1, further comprising of processing the presentation of results according to the determination of file scores.

17. The method in claim 1, further comprising of processing results according to taxonomic classification.

18. The method in claim 1, further comprising of processing results according to semantic interpretations.

19. The method in claim 1, wherein the said predetermined taxonomies comprising:
considering file attributes;
considering system attributes;
considering custom attributes;
considering ontologies faceted taxonomies; and
considering semantic relationships among features.

20. The method in claim 1, further comprising of processing results for further operations through the integration with other components or modules via a graphical user interface, script, internet browser, web service, database, or markup languages.
